(19) United States
(12) Patent Application Publication
(10) Pub. No.: US 2024/0427961 A1
(43) Pub. Date: Dec. 26, 2024

(54) TWO-PHASE NUMERICAL SIMULATION METHOD FOR MICROCHANNEL HEAT EXCHANGER

(71) Applicant: Xi'an Jiaotong University, Xi'an (CN)

(72) Inventors: Ting Ma, Xi'an (CN); Zicheng Tang, Xi'an (CN); Song He, Xi'an (CN); Rui Gu, Xi'an (CN); Yining Wu, Xi'an (CN); Min Zeng, Xi'an (CN); Qiuwang Wang, Xi'an (CN)

(21) Appl. No.: 18/826,137

(22) Filed: Sep. 5, 2024

(30) Foreign Application Priority Data
Dec. 21, 2023 (CN) 202311764108.3

(51) Int. Cl. G06F 30/20; G06F 113/08

(52) U.S. Cl. CPC G06F 30/20; F28F 2200/00; F28F 2260/02; G06F 2113/08

(57) ABSTRACT

The present invention discloses a two-phase numerical simulation method for a microchannel heat exchanger, and the method includes: simplifying a real heat exchange channel into a porous medium model. Governing equations are determined according to two-phase flow and heat transfer characteristics thereof, and the equations are solved iteratively until results converge to complete numerical simulation. The present invention is beneficial to promoting optimization design of two-phase flow microchannel heat exchangers.

### TECHNICAL FIELD

The present invention pertains to the technical field of numerical simulation of flow and heat transfer in a heat exchanger, and particularly pertains to a two-phase numerical simulation method for a microchannel heat exchanger.

### BACKGROUND

Microchannel heat exchangers have the advantages of high compactness, high heat exchange efficiency, small heat transfer temperature difference, etc., and are widely used in many fields such as energy and chemical industry, aerospace, and electronic machinery. Two-phase heat exchange of microchannel heat exchangers is one of the effective solutions to solve heat dissipation problem of high heat flux density devices. A characteristic size of the channels is generally less than 1 mm, and two-phase flow also involves complex problems such as two-phase instability and uneven phase distribution. Therefore, it is difficult to carry out numerical simulation.

Conventional two-phase simulation is based on real structure modeling and gridding, and a flow field and a temperature field are obtained by discretely solving governing equations of the two-phase flow by a computer, which has problems such as a large calculation amount and difficult convergence of results. In order to reduce the calculation amount, for a microchannel heat exchanger with a large number of channels, usually only a few channels of a core is selected in the conventional two-phase numerical simulation method for local numerical simulation, which can not reflect overall flow and heat transfer characteristics of the heat exchanger, and makes difficult to study influence of flow division characteristics of a heat exchanger head on the two-phase flow and heat transfer inside the channels.

### SUMMARY

The technical problem to be solved by the present invention is to provide a two-phase numerical simulation method for a microchannel heat exchanger, which improves heat exchange efficiency of the heat exchanger.

In order to solve the above technical problem, the technical solution of the present invention is as follows.

In a first aspect, a two-phase numerical simulation method for a microchannel heat exchanger, includes:
acquiring a viscous drag coefficient, an inertial drag coefficient, a convective heat transfer coefficient and a heat transfer area density in heat exchange channels;
performing three-dimensional modeling on a two-phase flow layer in the microchannel heat exchanger to obtain a numerical simulation calculation model;
determining governing equations for a two-phase flow region and a solid region according to the viscous drag coefficient, the inertial drag coefficient, the convective heat transfer coefficient and the heat transfer area density in the heat exchange channels, and based on a local non-thermal equilibrium heat transfer model of a porous medium;
iteratively solving the governing equations to obtain a velocity distribution and a temperature distribution of two-phase flow and a temperature distribution of the solid region; and
iteratively solving the governing equations repeatedly until results converge to finally obtain a flow field and a temperature field of the two-phase flow region and a temperature field of the solid region, and performing analysis and post-processing to obtain flow and heat transfer characteristics of the two-phase flow region.

Further, performing three-dimensional modeling on a two-phase flow layer in the microchannel heat exchanger to obtain a numerical simulation calculation model, includes:
transforming a plurality of microchannels into a whole;
establishing solid models with a same size according to a size of the two-phase flow layer; and
performing structured gridding on the two solid models respectively to finally result in a layer of two-phase flow grids and a layer of solid grids with a same number and size as the two-phase flow grids.

Further, iteratively solving the governing equations to obtain a velocity distribution and a temperature distribution of two-phase flow and a temperature distribution of the solid region, includes:
based on a finite volume method, the governing equations for the two-phase flow region and the solid region are solved discretely to complete a calculation iteration to obtain the velocity distribution and the temperature distribution of the two-phase flow and the temperature distribution of the solid region.

Further, iteratively solving the governing equations repeatedly until results converge to finally obtain a flow field and a temperature field of the two-phase flow region and a temperature field of the solid region, and performing analysis and post-processing to obtain flow and heat transfer characteristics of the two-phase flow region, includes:
each time the governing equation is solved iteratively, the grids of the two-phase flow region read temperature data of the solid grids in one-to-one positional correspondence to the two-phase flow region, and the solid grids simultaneously reads temperature data of the two-phase flow in one-to-one positional correspondence;
substituting the temperature data of the solid grids and the temperature data of the two-phase flow into source terms in respective energy equations to continue calculation to complete a next iteration process; and
repeating the iterative calculation process until the results converge to finally obtain the flow field and the temperature field of the two-phase flow region and the temperature field of the solid region, and performing analysis and post-processing to obtain the flow and heat transfer characteristics of the two-phase flow region.

Further, an overall positional relationship between the two-phase flow region and the solid region may be overlapping, parallel or perpendicular, or other positional relationship capable of being expressed by a function.

Further, a relative position between each grid in the two-phase flow region and a region boundary is in one-to-one correspondence to a relative position between each grid in the solid region and a region boundary.

Further, data transmission designed according to a positional relationship is provided between the two-phase flow region and the solid region, and each grid of the two-phase flow region performs temperature data transmission with solid grid in one-to-one positional correspondence each time the calculation iteration is completed, and the temperature data is substituted into the source terms in the respective energy equations for a next iterative calculation to realize coupled heat transfer between the two-phase flow region and the solid region.

In a second aspect, a two-phase numerical simulation apparatus for a microchannel heat exchanger, includes:
an acquisition module configured for acquiring a viscous drag coefficient, an inertial drag coefficient, a convective heat transfer coefficient and a heat transfer area density in heat exchange channels; and
a processing module configured for determining governing equations for a two-phase flow region and a solid region according to the viscous drag coefficient, the inertial drag coefficient, the convective heat transfer coefficient and the heat transfer area density in the heat exchange channels, and based on a local non-thermal equilibrium heat transfer model of a porous medium; iteratively solving the governing equations to obtain a velocity distribution and a temperature distribution of two-phase flow and a temperature distribution of the solid region; and iteratively solving the governing equations repeatedly until results converge to finally obtain a flow field and a temperature field of the two-phase flow region and a temperature field of the solid region, and performing analysis and post-processing to obtain flow and heat transfer characteristics of the two-phase flow region.

In a third aspect, a two-phase numerical simulation device for a microchannel heat exchanger, includes:
one or more processors; and
a storage configured for storing one or more programs which, when executed by the one or more processors, cause the one or more processors to implement the method.

In a fourth aspect, a computer readable storage medium having stored therein a program which, when executed by a processor, implements the method.

The above solution of the present invention includes at least the following beneficial effects.

In the above solution of the present invention, based on the local non-thermal equilibrium heat transfer model of the porous medium, the two-phase flow layer of the microchannel heat exchanger is simplified into a porous medium model, and the original real structure channels are simplified into a layer of porous medium fluid region and a layer of porous medium solid region. The method can reduce a large number of calculation grids, significantly reduce the gridding workload and the calculation amount of iterative solution, and effectively avoid the problem of difficult convergence of calculation results in the two-phase flow simulation. Based on a smaller number of grids and a smaller amount of calculation, the method provided by the present invention can be used to solve the problem of conventional two-phase flow simulation, is beneficial to promoting optimization design of two-phase flow microchannel heat exchangers, and further improves the heat exchange efficiency of the heat exchangers.

### BRIEF DESCRIPTION OF THE DRAWINGS

FIG. 1 is a flow chart of a two-phase numerical simulation method for a microchannel heat exchanger according to the present invention.

FIG. 2 is a schematic diagram of data transfer between a two-phase flow region grid and a solid grid.

FIG. 3 is a schematic diagram of a two-phase numerical simulation apparatus for a microchannel heat exchanger according to the present invention.

FIG. 4 is a schematic diagram of a conventional microchannel heat exchanger simulation model.

FIG. 5 is a schematic diagram of a plate layer structure of a conventional microchannel heat exchanger simulation model.

FIG. 6 is a schematic diagram of a numerical simulation model for a microchannel heat exchanger according to the present invention.

FIG. 7 is a schematic diagram of a plate layer structure of a numerical simulation model for a microchannel heat exchanger according to the present invention.

### DESCRIPTION OF THE EMBODIMENTS

Exemplary embodiments of the present disclosure will be described in more detail below with reference to the accompanying drawings. While the drawings show exemplary embodiments of the present disclosure, it should be understood that the present disclosure may be embodied in various forms and should not be construed as limited to the embodiments set forth herein. Rather, these embodiments are provided so that the present disclosure will be thorough and complete, and will fully convey the scope of the present disclosure to those skilled in the art.

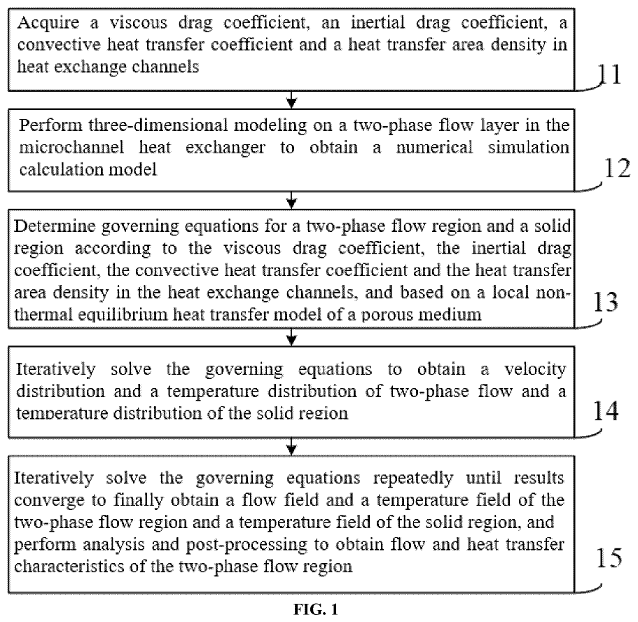

As shown in FIG. 1, embodiments of the present invention provide a two-phase numerical simulation method for a microchannel heat exchanger, and the method includes the following steps:
step 11, acquiring a viscous drag coefficient, an inertial drag coefficient, a convective heat transfer coefficient and a heat transfer area density in heat exchange channels;
step 12, performing three-dimensional modeling on a two-phase flow layer in the microchannel heat exchanger to obtain a numerical simulation calculation model;
step 13, determining governing equations for a two-phase flow region and a solid region according to the viscous drag coefficient, the inertial drag coefficient, the convective heat transfer coefficient and the heat transfer area density in the heat exchange channels, and based on a local non-thermal equilibrium heat transfer model of a porous medium;
step 14, iteratively solving the governing equations to obtain a velocity distribution and a temperature distribution of two-phase flow and a temperature distribution of the solid region; and
step 15, iteratively solving the governing equations repeatedly until results converge to finally obtain a flow field and a temperature field of the two-phase flow region and a temperature field of the solid region, and performing analysis and post-processing to obtain flow and heat transfer characteristics of the two-phase flow region.

In the embodiments of the present invention, based on the local non-thermal equilibrium heat transfer model of the porous medium, the two-phase flow layer of the microchannel heat exchanger is simplified into a porous medium model, and the original real structure channels are simplified into a layer of porous medium fluid region and a layer of porous medium solid region. The method can reduce a large number of calculation grids, significantly reduce the gridding workload and the calculation amount of iterative solution, and effectively avoid the problem of difficult convergence of calculation results in the two-phase flow simulation. Based on a smaller number of grids and a smaller amount of calculation, the method provided by the present invention can be used to solve the problem of conventional two-phase flow simulation, is beneficial to promoting optimization design of two-phase flow microchannel heat exchangers, and further improves the heat exchange efficiency of the heat exchangers.

In a preferred embodiment of the present invention, the above step 12 may include: step 121, transforming a plurality of microchannels into a whole;
step 122, establishing solid models with a same size according to a size of the two-phase flow layer; and
step 123, performing structured gridding on the two solid models respectively to finally result in a layer of two-phase flow grids and a layer of solid grids with a same number and size as the two-phase flow grids.

In the embodiments of the present invention, transforming a plurality of microchannels into a whole simplifies a physical model and reduces the calculation amount; establishing the solid models with the same size ensures grid matching between the solid region and the fluid region; performing structured gridding avoids the trouble of irregular grids and simplifies grid generation; using the two-layer grid structure with one layer for the fluid and one layer for the solid avoids complexity of embedded grids; and complete matching of the fluid grids and the solid grids in terms of number and size facilitates the calculation of heat transfer; all of which greatly reduce the number of grids, reduce the calculation amount, simplify gridding, improves efficiency, and avoid the problem of difficult convergence of the calculation results. Therefore, the method can be used to solve the simulation problem of two-phase flow microchannels and is beneficial to the optimization design of the microchannel heat exchangers.

In a preferred embodiment of the present invention, the above step 14 may include:
step 141, based on a finite volume method, the governing equations for the two-phase flow region and the solid region are solved discretely to complete a calculation iteration to obtain the velocity distribution and the temperature distribution of the two-phase flow and the temperature distribution of the solid region.

In the embodiments of the present invention, use of the finite volume method ensures that the conservation law is satisfied and the calculation results are more accurate and reliable; the fluid region and the solid region are solved respectively, which considers different physical characteristics of the two regions, and can reduce the calculation amount and improve calculation speed, and provides a detailed numerical simulation means for the two-phase flow and heat transfer, which is beneficial to optimizing flow and heat transfer performance in the microchannels and improve the heat exchange efficiency.

In a preferred embodiment of the present invention, the above step 15 may include:
step 151, each time the governing equation is solved iteratively, the grids of the two-phase flow region read temperature data of the solid grids in one-to-one positional correspondence to the two-phase flow region, and the solid grids simultaneously reads temperature data of the two-phase flow in one-to-one positional correspondence;
step 152, substituting the temperature data of the solid grids and the temperature data of the two-phase flow into source terms in respective energy equations to continue calculation to complete a next iteration process; and
step 153, repeating the iterative calculation process until the results converge to finally obtain the flow field and the temperature field of the two-phase flow region and the temperature field of the solid region, and performing analysis and post-processing to obtain the flow and heat transfer characteristics of the two-phase flow region; an overall positional relationship between the two-phase flow region and the solid region may be overlapping, parallel or perpendicular, or other positional relationship that may be expressed by a function; a relative position between each grid in the two-phase flow region and a region boundary is in one-to-one correspondence to a relative position between each grid in the solid region and a region boundary; and data transmission designed according to a positional relationship is provided between the two-phase flow region and the solid region, and each grid of the two-phase flow region performs temperature data transmission with solid grid in one-to-one positional correspondence each time the calculation iteration is completed, and the temperature data is substituted into the source terms in the respective energy equations for a next iterative calculation to realize coupled heat transfer between the two-phase flow region and the solid region.

In the embodiments of the present invention, temperature data transmission with one-to-one positional correspondence is provided between the fluid grid and the solid grid; after each iteration, the fluid grids and the solid grids exchange the temperature data which is used as the source term of the energy equation to participate in the next iterative calculation, and the iterative heat transfer calculation is repeated until the result converges, which realize the coupled heat transfer between the fluid region and the solid region, and considers heat transfer interaction between the two-phase fluid and the solid; and the flow field, the temperature field and the temperature distribution of the solid are calculated, and the flow and heat transfer characteristics of the two-phase fluid are obtained through analysis; all of which avoid the complexity of the traditional embedded grid, simplify grid processing, reduce the calculation amount, improve numerical calculation accuracy and efficiency, provide an effective means for the study of the heat transfer characteristics of the two-phase fluid, and are conducive to optimization design of two-phase flow heat exchangers. In summary, the calculation mode fully considers the heat transfer interaction between fluid and solid, and achieves effective coupled heat transfer calculation, which provides a simplified and efficient calculation solution for two-phase fluid numerical simulation.

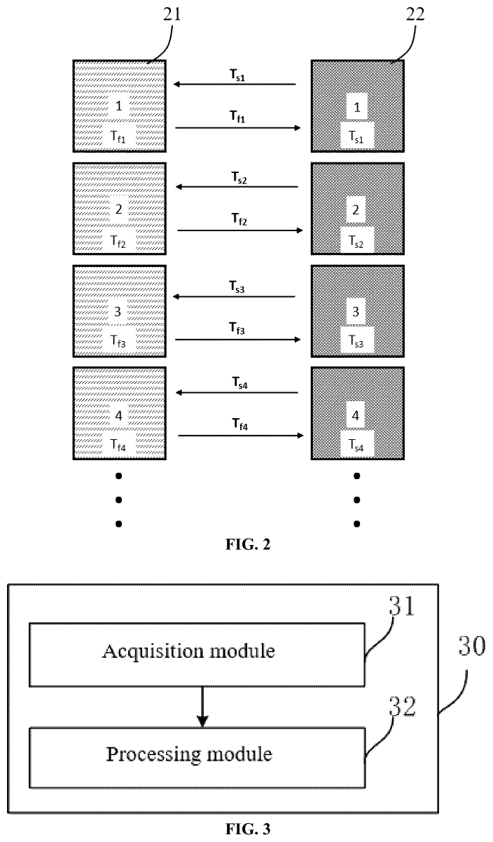

Referring to FIGS. 1 and 2, taking a Mixture two-phase flow model in a two-phase flow region as an example, a two-phase numerical simulation method for a microchannel heat exchanger, includes the following steps.

Step 1, a two-phase flow region is simplified into a porous medium region by defining a viscous drag coefficient, an inertial drag coefficient, a convective heat transfer coefficient and a heat transfer area density in heat exchange channels. The viscous drag coefficient, the inertial drag coefficient and the convective heat transfer coefficient of a mixed phase are derived from an empirical correlation of flow and heat transfer in the heat exchange channels, and may also be obtained by formula fitting of flow and heat transfer data obtained by experimental test or local numerical simulation. The heat transfer area density is calculated according to a real channel structure. Four parameters are calculated as follows:

$${f}_{h} = \frac{{C}_{1}}{{Re}_{h}} + {C}_{2 ,}$$

$$D = \frac{{C}_{1}}{2 {d}_{h}^{2} γ} ,$$

$$C = \frac{{C}_{2}}{{γ}^{2} {d}_{h}} ,$$

$${h}_{tp} = ψ {h}_{sp} ,$$

$${ρ}_{A} = \frac{A}{V} ;$$

Where fₕ and Reₕ are respectively a friction factor and a Reynolds number of the mixed phase, C₁ and C₃ are intermediate parameters, D and C are respectively a viscous drag coefficient and an inertial drag coefficient of a porous medium, γ is a porosity of the porous medium, d_{B}s is a characteristic length of the microchannels, hₜₚ and hₛₚ are respectively a two-phase convective heat transfer coefficient and a single-phase convective heat transfer coefficient, ψ is an empirical coefficient, β_{A} is a heat transfer area density, and A and V are respectively a heat transfer area and a total volume of a two-phase flow layer in the microchannel heat exchanger.

Step 2, the two-phase flow layer in the microchannel heat exchanger is subject to three-dimensional modeling. During modeling, a plurality of microchannels are simplified into a whole, and solid models with a same size are respectively established according to a size of the two-phase flow layer, and the two solid models are respectively subject to structured gridding. The finally formed grid model consists of a layer of two-phase flow grids and a layer of solid grids with a same number and size as the two-phase flow grids; a positional relationship between the two-phase flow region and a solid region includes but not limited to overlapping, being parallel, being perpendicular or other positional relationship that may be expressed by a function, but a relative position between each grid in the two-phase flow region and a region boundary is in one-to-one correspondence to a relative position between each grid in the solid region and a region boundary.

Step 3, governing equations for a mixed phase region and the solid region are determined according to the parameters of the porous medium obtained in step 1 and based on a local non-thermal equilibrium heat transfer model of the porous medium. Energy source terms in the governing equations are used to couple heat transfer in the two-phase flow region with heat transfer in the solid region. Meanwhile, initial conditions and boundary conditions for the simulation are determined according to actual situation.

A continuity equation of the mixed phase based on the porous medium model and the Mixture model is as follows:

$$\frac{\partial }{\partial t} ( {w}_{m} {ρ}_{m} ) + ∇ \times ( {w}_{m} {ρ}_{m} {\vec{v}}_{m} ) = 0 ,$$

where βₘ and νₘ are respectively an effective density and a mass mean velocity of the mixed phase,

$${w}_{m} = \frac{1}{1 + α {ρ}_{m}} ,$$

and α is a constant.

A momentum equation of the mixed phase based on the porous medium model and the Mixture model is as follows:

$$\frac{\partial }{\partial t} ( γ {ρ}_{m} {\vec{v}}_{m} ) + ∇ \cdot ( γ {ρ}_{m} {\vec{v}}_{m} {\vec{v}}_{m} ) = - γ ∇ p + ∇ \cdot [ γ {μ}_{m} ( ∇ {\vec{v}}_{m} + ∇ {\vec{v}}_{m}^{T} ) ] + γ {ρ}_{m} \vec{g} + γ \vec{F} - ∇ \cdot ( γ {\sum }_{k = 1}^{n} {α}_{k} {ρ}_{k} {\vec{v}}_{dr , k} {\vec{v}}_{dr , k} ) + {\sum }_{i = 1}^{3} {s}_{i} ;$$

$${s}_{i} = - ( {\sum }_{j = 1}^{3} {D}_{ij} {μ}_{m} {v}_{mj} + {\sum }_{j = 1}^{3} \frac{1}{2} {C}_{ij} {ρ}_{m} \vert {v}_{m} \vert {v}_{mj} ) ;$$

where γ is the porosity of the porous medium, μₘ is an effective viscosity of the mixed phase, g is an acceleration of gravity, F is a force vector, αₖ, βₖ and V_{dr,k} are respectively a volume fraction, a density and an interphase drift velocity of a kth phase, Sᵢ is a momentum source term in an i direction, Dᵢⱼ is a viscous drag coefficient matrix, is an inertial drag coefficient matrix, νₘⱼ is a velocity component of the mixed phase, and influence of the porous medium model on the flow governing equation is that a momentum source term is superimposed in the governing equation.

An energy equation of the mixed phase based on the porous medium model and the Mixture model is as follows:

$$\frac{\partial }{\partial t} {\sum }_{K = 1}^{n} ( γ {w}_{k} {γ}_{k} {a}_{k} {ρ}_{k} {E}_{k} ) + ∇ \times {\sum }_{k = 1}^{n} ( γ {w}_{vk} {α}_{k} \vec{v} ( ρ kE + p ) ) = ∇ \times ( {w}_{T} {k}_{eff} ∇ T ) + {w}_{S} {S}_{E} ;$$

$${k}_{eff} = γ {sk}_{l} + γ ( 1 - s ) {k}_{v} ;$$

$${S}_{E} = {h}_{tp} {ρ}_{A} ( {T}_{s} - {T}_{m} ) ;$$

where Eₖ is a transient term coefficient of the kth phase, ρ is pressure, k_{eff} k₁ and kᵥ are respectively an effective thermal conductivity, a liquid phase thermal conductivity and a gas phase thermal conductivity, S is a liquid phase saturation, S_{E} is an energy source term of the mixed phase, Tₛ and Tₘ are respectively a solid temperature and a mixed phase temperature,

$${w}_{k} = \frac{1}{1 + {β}_{k} {γ}_{k} {α}_{k} {ρ}_{k}}$$

is a weight coefficient of a transient term,

$${w}_{vk} = \frac{1}{1 + {η}_{k} {α}_{k} {ρ}_{k}}$$

is a weight coefficient of a convection term,

$${w}_{T} = \frac{1}{1 + ζ {k}_{eff}}$$

is a weight coefficient of a heat conduction term,

$${w}_{S} = \frac{1}{1 + ξ {S}_{E}}$$

is a weight coefficient of the source term, βₖ and ηₖ and ζ are constants.

A volume fraction equation of the kth phase based on the Mixture model is as follows:

$$\frac{\partial }{\partial t} ( γ {α}_{k} {ρ}_{k} ) + ∇ \cdot ( γ {α}_{k} {ρ}_{k} {\vec{v}}_{m} ) = - ∇ \cdot ( γ {α}_{k} {ρ}_{k} {\vec{v}}_{dr , k} ) + γ {\sum }_{q = 1}^{n} ( {\dot{m}}_{qk} - {\dot{m}}_{kq} ) .$$

A solid energy equation based on the porous medium model is as follows:

$$\frac{\partial }{\partial t} ( {w}_{1} ( 1 - γ ) {ρ}_{s} {E}_{s} ) = ∇ \times ( {w}_{2} ( 1 - γ ) {k}_{s} ∇ {T}_{s} ) + {w}_{3} {S}_{s} ;$$

$${S}_{s} = {h}_{tp} {ρ}_{A} ( {T}_{m} - {T}_{s} ) ;$$

where βs Eₛ kₛ and Sₛ are respectively are a solid density, a solid unsteady state coefficient, a solid thermal conductivity and a solid energy source term, \dot{m}_{qk} and \dot{m}_{kq} are respectively a mass transfer rate from a qth phase to the kth phase and a mass transfer rate from the kth phase to the qth phase, w₁, w₂ and w₃ are weight parameters,

$${w}_{1} = \frac{1}{1 + α {p}_{s}} ,$$

$${w}_{2} = \frac{1}{1 + β {k}_{s}} ,$$

$${w}_{3} = \frac{1}{1 + {γ}_{1} {S}_{s}} ,$$

where α, β, and γ₁ are constants.

Step 4, based on a finite volume method, firstly, the continuity equation, the momentum equation and the energy equation of the mixed phase in the two-phase flow region are solved discretely to obtain a velocity distribution and a temperature distribution of the mixed phase, then the volume fraction equation is solved discretely to obtain a phase distribution of the two-phase flow, while the energy equation of the solid region is solved discretely to obtain a temperature distribution of the solid region, thus completing a calculation iteration.

Step 5, data transmission is designed according to the positional relationship between the two-phase flow region and the solid region, as shown in FIG. 2, numbers 1, 2, 3 and 4 in the figure are grid numbers of grids 21 in the two-phase flow region and grids 22 in the solid region, and T_{f} and Tₛ are temperatures of the grids 21 in the two-phase flow region and the grids 22 in the solid region respectively. Each time the calculation iteration in step 4 is completed, the grids 21 in the two-phase flow region read temperature data of the grids 22 in the solid region grid in one-to-one positional correspondence obtained from last iterative solution, and the grids in the solid region 22 also reads temperature data of the mixed phase in the grids 21 in the two-phase flow region in one-to-one positional correspondence obtained from the last iterative solution; after the reading is completed, it is required to perform step 4 at which the temperature data is substituted into the source terms in the respective energy equations for a next iterative calculation to realize coupled heat transfer between the two-phase flow region and the solid region.

Step 6, the iterative calculation process of steps 4 and 5 are repeated until the results converge to finally obtain a flow field and a temperature field of the two-phase flow region, a phase distribution of a gas phase and a liquid phase, and a temperature field of the solid region, and the calculation results are subject to analysis and post-processing to obtain flow and heat transfer characteristics of the two-phase flow region.

As shown in FIG. 3, embodiments of the present invention also provide a two-phase numerical simulation apparatus 30 for a microchannel heat exchanger, including:
an acquisition module 31 configured for acquiring a viscous drag coefficient, an inertial drag coefficient, a convective heat transfer coefficient and a heat transfer area density in heat exchange channels; and
a processing module 32 configured for determining governing equations for a two-phase flow region and a solid region according to the viscous drag coefficient, the inertial drag coefficient, the convective heat transfer coefficient and the heat transfer area density in the heat exchange channels, and based on a local non-thermal equilibrium heat transfer model of a porous medium; iteratively solving the governing equations to obtain a velocity distribution and a temperature distribution of two-phase flow and a temperature distribution of the solid region; and iteratively solving the governing equations repeatedly until results converge to finally obtain a flow field and a temperature field of the two-phase flow region and a temperature field of the solid region, and performing analysis and post-processing to obtain flow and heat transfer characteristics of the two-phase flow region.

Optionally, performing three-dimensional modeling on a two-phase flow layer in the microchannel heat exchanger to obtain a numerical simulation calculation model, includes:
transforming a plurality of microchannels into a whole;
establishing solid models with a same size according to a size of the two-phase flow layer; and
performing structured gridding on the two solid models respectively to finally result in a layer of two-phase flow grids and a layer of solid grids with a same number and size as the two-phase flow grids.

Optionally, iteratively solving the governing equations to obtain a velocity distribution and a temperature distribution of two-phase flow and a temperature distribution of the solid region, includes:
based on a finite volume method, the governing equations for the two-phase flow region and the solid region are solved discretely to complete a calculation iteration to obtain the velocity distribution and the temperature distribution of the two-phase flow and the temperature distribution of the solid region.

Optionally, iteratively solving the governing equations repeatedly until results converge to finally obtain a flow field and a temperature field of the two-phase flow region and a temperature field of the solid region, and performing analysis and post-processing to obtain flow and heat transfer characteristics of the two-phase flow region, includes:
each time the governing equation is solved iteratively, the grids of the two-phase flow region read temperature data of the solid grids in one-to-one positional correspondence to the two-phase flow region, and the solid grids simultaneously reads temperature data of the two-phase flow in one-to-one positional correspondence;
substituting the temperature data of the solid grids and the temperature data of the two-phase flow into source terms in respective energy equations to continue calculation to complete a next iteration process; and
repeating the iterative calculation process until the results converge to finally obtain the flow field and the temperature field of the two-phase flow region and the temperature field of the solid region, and performing analysis and post-processing to obtain the flow and heat transfer characteristics of the two-phase flow region.

Optionally, an overall positional relationship between the two-phase flow region and the solid region may be overlapping, parallel or perpendicular, or other positional relationship that may be expressed by a function.

Optionally, a relative position between each grid in the two-phase flow region and a region boundary is in one-to-one correspondence to a relative position between each grid in the solid region and a region boundary.

Optionally, data transmission designed according to a positional relationship is provided between the two-phase flow region and the solid region, and each grid of the two-phase flow region performs temperature data transmission with solid grid in one-to-one positional correspondence each time the calculation iteration is completed, and the temperature data is substituted into the source terms in the respective energy equations for the next iterative calculation to realize coupled heat transfer between the two-phase flow region and the solid region.

It should be noted that the apparatus is an apparatus corresponding to the above method, and all implementations of the embodiments of the above method are applicable to the present embodiment and can achieve the same technical effect.

Embodiments of the present invention also provide a two-phase numerical simulation device for a microchannel heat exchanger, including: a processor; a memory having stored therein a computer program, when executed by the processor, performs the method as described above.

All implementations of the embodiments of the above method are applicable to the present embodiment and can achieve the same technical effect.

Embodiments of the present invention also provide a computer-readable storage medium storing instructions which, when executed on a computer, cause the computer to perform the method as described above. All implementations of the embodiments of the above method are applicable to the present embodiment and can achieve the same technical effect.

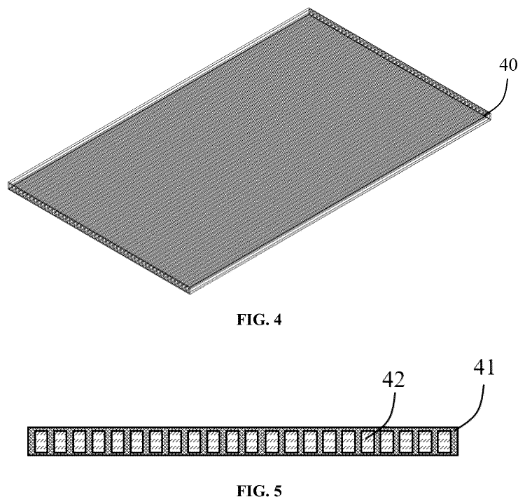

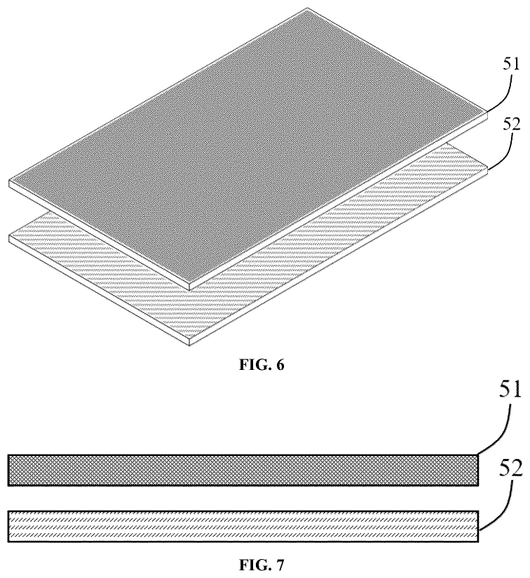

As shown in FIGS. 4 to 7, a numerical simulation model provided by a conventional numerical simulation method is a heat exchange plate layer 40 arranged according to a real microchannel structure, which includes solid grids 41 of the real channel structure and fluid grids 42 of the real channel structure, and in order to ensure numerical simulation convergence and accuracy, a very small grid size and a large number of boundary layer grids are required. The numerical simulation model provided by the present invention can simplify the complex channel structure. That is, calculation grids are simplified into a whole layer of solid grids 51 and a whole layer of fluid grids 52, which facilitates structured gridding, can adapt to a larger grid size and avoid dividing the fluid region into the boundary layer grids, can reduce a large number of calculation grids, and can significantly reduce gridding workload and the calculation amount of iterative solution, thus effectively avoiding the problem of difficult convergence of calculation results in two-phase flow simulation.

Those of ordinary skill in the art would appreciate that various illustrative units and algorithm steps described in connection with the embodiments disclosed herein can be implemented in electronic hardware or a combination of computer software and the electronic hardware. Whether these functions are executed in hardware or software depends on the specific application and design constraints of the technical solution. Those skilled in the art may use different methods for each particular application to implement the described functions, but such implementations should not be considered beyond the scope of the present invention.

It will be clear to those skilled in the art that, for convenience and brevity of description, the specific working procedures of the above-described system and unit may refer to the corresponding procedures in the foregoing method embodiments, which are not repeated here.

In the embodiments provided in the present invention, it should be understood that the disclosed apparatus and method may be implemented in other ways. For example, the apparatus embodiments described above are merely illustrative. For example, the division of the units is merely a logical function division. In actual implementations, there may be another division manner, for example, multiple units or components may be combined or may be integrated into another system, or some features may be ignored or not executed. In addition, the mutual coupling or direct coupling or communication connection shown or discussed may be an indirect coupling or communication connection via some interfaces, apparatus or units, and may be in an electrical, mechanical or other forms.

The units described as separate components may or may not be physically separated, and the components displayed as units may or may not be physical units, which may be located in one place or distributed to multiple network units. Some or all of the units can be selected according to actual needs to achieve the purpose of the present embodiment.

In addition, each functional unit in each embodiment of the present invention may be integrated into one processing unit, or each unit may exist physically separated, or two or more units may be integrated into one unit.

The functions, if implemented in software functional units and sold or used as stand-alone products, may be stored in a computer-readable storage medium. Based on such understanding, the technical solution of the present invention essentially or in part contributing to the prior art or part of the technical solution may be embodied in the form of a software product. The computer software product is stored in a storage medium and includes several instructions to cause a computer device (which may be a personal computer, a server, or a network device, etc.) to execute all or part of the steps of the methods described in various embodiments of the present invention. The above-mentioned storage medium includes various media capable of storing program codes, such as a U disk, a mobile hard disk, a Read-Only Memory (ROM), a Random Access Memory (RAM), a magnetic disk or an optical disk.

Furthermore, it should be noted that in the apparatus and method of the present invention, it is apparent that the components or steps may be decomposed and/or recombined. Such decompositions and/or recombinations should be considered as equivalents of the present invention. Also, the steps of performing the series of processes described above may naturally be performed chronologically in the order described, but need not necessarily be performed chronologically, and some steps may be performed in parallel or independently of each other. It will be understood by those skilled in the art that all or any of the steps or components of the method and apparatus of the present invention may be implemented in any computing device (including processors, storage media, etc.) or networks of computing devices, in hardware, firmware, software, or any combination thereof, which can be implemented by those skilled in the art using their basic programming skills after reading the description of the present invention.

Thus, the object of the present invention may also be achieved by running a program or a set of programs on any computing device. The computing device may be a well-known general-purpose device. Thus, the object of the present invention may also be achieved solely by providing a program product containing a program code for implementing the method or the apparatus. That is, such a program product also constitutes the present invention, and a storage medium storing such a program product also constitutes the present invention. Obviously, the storage medium may be any known storage medium or any storage medium developed in the future. It should also be noted that in the apparatus and method of the present invention, it is apparent that the components or steps may be decomposed and/or recombined. Such decompositions and/or recombinations should be considered as equivalents of the present invention. Also, the steps of performing the series of processes described above may naturally be performed chronologically in the order described, but need not necessarily be performed chronologically. Some steps may be performed in parallel or independently of each other.

The present invention has been described with reference to the foregoing preferred embodiments, it should be noted that those of ordinary skill in the art can make several improvements and modifications without departing from the principles of the present invention, and such improvements and modifications shall be construed to fall into the scope of the present invention.

What is claimed is:

1. A two-phase numerical simulation method for a microchannel heat exchanger, the method comprising:
acquiring a viscous drag coefficient, an inertial drag coefficient, a convective heat transfer coefficient and a heat transfer area density in heat exchange channels;
performing three-dimensional modeling on a two-phase flow layer in the microchannel heat exchanger to obtain a numerical simulation calculation model, comprising: transforming a plurality of microchannels into a whole; establishing solid models with a same size according to a size of the two-phase flow layer; and performing structured gridding on the two solid models respectively to finally result in a layer of two-phase flow grids and a layer of solid grids with a same number and size as the two-phase flow grids;
determining governing equations for a two-phase flow region and a solid region according to the viscous drag coefficient, the inertial drag coefficient, the convective heat transfer coefficient and the heat transfer area density in the heat exchange channels, and based on a local non-thermal equilibrium heat transfer model of a porous medium;
iteratively solving the governing equations to obtain a velocity distribution and a temperature distribution of two-phase flow and a temperature distribution of the solid region; and
iteratively solving the governing equations repeatedly until results converge to finally obtain a flow field and a temperature field of the two-phase flow region and a temperature field of the solid region, and performing analysis and post-processing to obtain flow and heat transfer characteristics of the two-phase flow region.

2. The two-phase numerical simulation method for the microchannel heat exchanger according to claim 1, wherein iteratively solving the governing equations to obtain the velocity distribution and the temperature distribution of two-phase flow and the temperature distribution of the solid region comprises:
based on a finite volume method, the governing equations for the two-phase flow region and the solid region are solved discretely to complete a calculation iteration to obtain the velocity distribution and the temperature distribution of the two-phase flow and the temperature distribution of the solid region.

3. The two-phase numerical simulation method for the microchannel heat exchanger according to claim 1, wherein iteratively solving the governing equations repeatedly until results converge to finally obtain the flow field and the temperature field of the two-phase flow region and the temperature field of the solid region, and performing analysis and post-processing to obtain flow and heat transfer characteristics of the two-phase flow region comprises:
each time the governing equation is solved iteratively, the grids of the two-phase flow region read temperature data of the solid grids in one-to-one positional correspondence to the two-phase flow region, and the solid grids simultaneously reads temperature data of the two-phase flow in one-to-one positional correspondence;
substituting the temperature data of the solid grids and the temperature data of the two-phase flow into source terms in respective energy equations to continue calculation to complete a next iteration process; and
repeating the iterative calculation process until the results converge to finally obtain the flow field and the temperature field of the two-phase flow region and the temperature field of the solid region, and performing analysis and post-processing to obtain the flow and heat transfer characteristics of the two-phase flow region.

4. The two-phase numerical simulation method for the microchannel heat exchanger according to claim 1, wherein an overall positional relationship between the two-phase flow region and the solid region is at least one of overlapping, being parallel or being perpendicular.

5. The two-phase numerical simulation method for the microchannel heat exchanger according to claim 1, wherein a relative position between each grid in the two-phase flow region and a region boundary is in one-to-one correspondence to a relative position between each grid in the solid region and a region boundary.

6. The two-phase numerical simulation method for the microchannel heat exchanger according to claim 1, wherein data transmission designed according to a positional relationship is provided between the two-phase flow region and the solid region, and each grid of the two-phase flow region performs temperature data transmission with solid grid in one-to-one positional correspondence each time the calculation iteration is completed, and the temperature data is substituted into the source terms in the respective energy equations for a next iterative calculation to realize coupled heat transfer between the two-phase flow region and the solid region.

7. A two-phase numerical simulation apparatus for a microchannel heat exchanger, comprising:
an acquisition module configured for acquiring a viscous drag coefficient, an inertial drag coefficient, a convective heat transfer coefficient and a heat transfer area density in heat exchange channels; performing three-dimensional modeling on a two-phase flow layer in the microchannel heat exchanger to obtain a numerical simulation calculation model, comprising: transforming a plurality of microchannels into a whole; establishing solid models with a same size according to a size of the two-phase flow layer; and performing structured gridding on the two solid models respectively to finally result in a layer of two-phase flow grids and a layer of solid grids with a same number and size as the two-phase flow grids; and
a processing module configured for determining governing equations for a two-phase flow region and a solid region according to the viscous drag coefficient, the inertial drag coefficient, the convective heat transfer coefficient and the heat transfer area density in the heat exchange channels, and based on a local non-thermal equilibrium heat transfer model of a porous medium; iteratively solving the governing equations to obtain a velocity distribution and a temperature distribution of two-phase flow and a temperature distribution of the solid region; and iteratively solving the governing equations repeatedly until results converge to finally obtain a flow field and a temperature field of the two-phase flow region and a temperature field of the solid region, and performing analysis and post-processing to obtain flow and heat transfer characteristics of the two-phase flow region.

8. A computing device, comprising:
one or more processors; and
a storage configured for storing one or more programs which, when executed by the one or more processors, cause the one or more processors to implement the method according to claim 6.

9. A computer-readable storage medium having stored therein a program which, when executed by a processor, implements the method according to claim 6.
